(19) United States
(12) Patent Application Publication
(10) Pub. No.: US 2011/0151505 A1
(43) Pub. Date: Jun. 23, 2011

(54) Substance for Specimen Preparations and Related Methods

(76) Inventor: Sherif K. Girees, Diamond Bar, CA (US)

(21) Appl. No.: 12/969,557

(22) Filed: Dec. 15, 2010

Related U.S. Application Data
(60) Provisional application No. 61/286,936, filed on Dec. 16, 2009.

(51) Int. Cl. G01N 1/40; G01N 21/00

(52) U.S. Cl. 435/40.51

(57) ABSTRACT

Disclosed are substances and methods for preparing cytological specimens.

### CROSS-REFERENCE TO RELATED APPLICATIONS

This application claims the benefit and priority of U.S. Prov. Pat. App. Ser. No. 61/286,936 (filed Dec. 16, 2009) entitled “SUBSTANCE FOR SPECIMEN PREPARATIONS AND RELATED METHODS” which document is hereby incorporated by reference into this application.

### STATEMENT REGARDING FEDERALLY SPONSORED RESEARCH OR DEVELOPMENT

None.

### BACKGROUND OF THE INVENTION

### Field of Invention

The present application is in the field of substances and methods for preparing cytological specimens.

### Background of the Invention

Microscopic observation and evaluation of cells is important in medical and other applications. For example: the Papanicolaou test (Pap test) places cells from a female's cervix under a microscope whereby the cells are examined for abnormalities that may indicate early stages of cervical cancer. Accordingly, there is a need for substances and methods for preparing cytological specimens.

For ordinary cytological specimen preparation, cells are typically collected and smeared on a glass microscopic slide. Thereafter, the collected cells will be prepared for evaluation, viewing and testing for specific characteristics. Smearing cells on the slide alone has not been completely satisfactory for preserving and observing the cells in many instances. Among other drawbacks, cell smearing results in cell clumps on the slide so that individual cells are obscured, damaged, and difficult to examine. Therefore, specimens will typically need to be suspended in some type of solution or preparation. Many of the existing solutions for specimen preparation are inadequate inasmuch as they may interfere with visibility with the microscope by distorting, or staining the specimen in question. Also, some of the existing specimen preparation formulations are inadequate because they either cause cells to clump up, or alternately, if the preparation has inadequate viscosity, the specimens may run off a slide so that inadequate sample size may be considered. Other preparations are inadequate because they will stain specimens or chemically alter the specimens so that subsequent testing for pathological or diagnostic criteria may be compromised. Therefore, a need has existed for substances and methods that avoid cell clumping, damage, and obstruction during the preparation of a specimen. There is also a need for a cellular preparation that will permit preservation of specimens and cells of interest so they will better maintain chemical/biological properties and may be clearly observed and tested.

Methods have been devised to avoid the above-mentioned drawbacks, however, the applicant believes those methods remain inadequate. For example, U.S. Pat. No. 5,143,627 (issued Sep. 1, 1992) discloses a method for providing a monolayer of cells to a slide comprising: (1) preserving a cell in a solution; (2) passing the cells through a screen whereby a single layer (i.e., mono-layer) of cells too large to pass collects thereon; and, (3) providing the collected layer of cells to a microscope slide. U.S. Pat. No. 6,657,003 (issued Dec. 2, 2003) discloses the step of coating a slide with an adhesive (amino-acid polymer, buffered cross-linking agent, and deionized water) before step (3) so that the monolayer of cells adheres to the slide. Although this method avoids cell clumping, damage, and obstruction, the method: does not produce a specimen with natural characteristics since smaller cells pass through the screen and cannot be observed; may require expensive equipment for drawing the cells through the screen and placing the cell layer on the slide; and/or may require the use of a new screen in each application to avoid cross contamination of specimens. As a result, there is a further need for improved substances and methods for preparing cytological specimens.

### SUMMARY OF THE INVENTION

It is an object of the present application to disclose substances and methods for preparing cytological specimens that avoid the drawbacks mentioned above. In one non-limiting example, the substance may be a solution comprised in part of a low concentration of gelatin content. A liquid substance is disclosed with preferable viscosities which may be used to suspend cells adequately on a slide. Further disclosed is a method of preparing a cytological specimen comprising steps which may include: (1) isolating and concentrating a specimen or cells of interest via centrifuging; (2) suspending at least one of the concentrated cells in a substance comprised in part of gelatinous material for observation and testing on a microscopic slide.

It is another object of the present application to disclose a more efficient and faster way to prepare cytological samples for microscopic evaluation.

It is yet a further object of the present application to disclose substances and methods for preparing cytological specimens wherein the use of expensive equipment and/or instruments in need of constant replacement is lessened.

It is yet a further object of the present application to disclose a substance, that is actually a gelatin hydrocolloid suspension with a gelatin component at a low concentration.

It is yet a further object of the present application to disclose substances and methods for preparing cytological specimens with naturally distributed characteristics.

### BRIEF DESCRIPTION OF THE FIGURES

The manner in which these objectives and other desirable characteristics can be obtained is explained in the following description and attached figures in which:

FIG. 1 is a process flow for preparing a gelatinous substance for use in the preparation of a cytological specimen.

FIG. 2 is a flow-chart for performing the steps of preparing a cytological specimen.

FIG. 3 is a grey-scale photograph of a Pap test cytological specimen prepared according to traditional methods of microscopic slide preparations.

FIG. 4 is a grey-scale photograph of a Pap test cytological specimen prepared according to the methods disclosed by this application.

FIG. 5 is a grey-scale photograph of a urine cytological specimen prepared according to traditional methods of microscopic slide preparations.

FIG. 6 is a grey-scale photograph of a urine cytological specimen prepared according to the methods disclosed by this application.

FIG. 7 is a grey-scale photograph of a pleural fluid cytological specimen prepared according to the methods disclosed by this application.

FIG. 8 is a structural diagram of gelatin.

FIG. 9 is an exemplary concentration versus absorption scatter plot.

It is to be noted, however, that the appended figures illustrate only typical embodiments of this invention, and therefore, are not to be considered limiting of its scope, for the invention may admit to other equally effective embodiments that will be appreciated by those reasonably skilled in the relevant arts.

### DETAILED DESCRIPTION OF PREFFERED EMBODIMENTS

In general, the present application discloses substances and methods for preparing cytological specimens. In a preferable embodiment, a substance for preparing cytological specimens is comprised in part of a gelatinous component, which is typically a long chain polymer derived from collagen. Specifically, gelatin is preferable since it is an irreversibly hydrolyzed form of collagen. In another preferable embodiment, the application discloses a method of preparing a cytological specimen using this substance featuring a concentration that is in part derived from this gelatin. The more specific aspects of the preferred embodiments are disclosed below in connection with the figures.

Referring first to FIG. 8, the gelatin may be a long chain polymer. Suitably, the gelatin may contain relatively high levels of the following amino acids: glycine (Gly) 26-34%; proline (Pro) 10-18%;and hydroxy proline (Hyp) 7-15% . Other amino acids present within the gelatin may include: alanine (Ala) 8-11%; arginine (Arg) 8-9%; aspartic acid (Asp) 6-7%; and glutamic acid (Glu) 10-12%. Typically, the gelatin is not a complete protein, suitably does not contain tryptophan, and is deficient in isoleucine, threonine, and methionine. Additionally, other sulfur-containing amino acids—cysteine and cystine—are preferably deficient or absent from the gelatin as well. Preferably, the percent of water within the gelatin will vary in the range of about 6 to 9%. The ash content will also vary in a range of about 0.1 to 3.25%. Suitably, the gelatin is amphoteric, meaning that it is neither acidic nor alkali, but rather possesses both properties depending on the nature of the solution within which the gelatin is present. Suitably, the isoelectric point (i.e., the pH at which the gelatin's charge in solution is neutral) of the gelatin is in a range of about 4.8 and 9.4, with acid processed gelatins having higher isoelectric points than alkali processed gelatins.

A first preferable embodiment disclosed by this application is a substance for suitably immobilizing an approximate monolayer of cells on a microscope slide. The substance may be a gelatin-water solution having an approximate concentration in a range of one gram per milliliter and 1 micro gram per milliliter for cytological applications. Suitably, the disclosed mixture is: (1) viscous enough to immobilize cells suspended therein when placed, typically via pipette, onto a microscope slide; and, (2) conducive to the observation of the suspended cells (e.g., colorless, non-hazardous, relatively non-reactive, and has a similar refractive-index as glass).

The above disclosed solution may be a hydrocolloid-type chemical mixture wherein gelatin particles are suspended in the water with an even dispersion. It is believed that hydrocolloid dispersion of the gelatin particles interacts with the cells to produce a similar distribution of cells as the gelatin particles within the substance. In addition to distributing the cells within the solution, the hydrocolloid dispersion of the gelatin particles preferably immobilizes the cells into an approximate monolayer of cells, which may be better viewed when pipetted onto a microscope slide. The substance is a hydrocolloid type of chemical mixture in which gelatin is dispersed evenly throughout the solution. The particles of gelatin are thus preferably suspended in the mixture. This occurs because the particles in a colloid are larger than in a solution, but small enough to be dispersed evenly and maintain a homogeneous appearance—while still large enough to scatter light and not dissolve. Because of this dispersal, the substance may have the appearance of solution.

Given the above characteristics, the exact preferable gelatin concentration within the solution will depend on the desirable light absorbance or refractive index (RI) for the cytological specimen to which the solution will be applied since the absorbance and RI of the specimen vary with the concentration. Suitably, the relationship, y=0.1485x²+0.346x−0.0002, between absorbance (x) and concentration (y in mg/mL) has been regressed using the Bradford method whereby an appropriate gelatin concentration within the solution may be produced given a desirable cytological specimen absorbance. A typical procedure for the regression involves the steps of: diluting the gelatin with distilled water; pipetting 100 ul of the diluted mixture into a well of a 96-well plate; adding 100 ul of diluted Coomassie Dye (7.5 ml of Coomassie Dye to 50 ml distilled water) to the dilute mixture; incubating the mixture with the dye for a period of five minutes whereby the dye binds to the gelatin and shifts (depending on the concentration of gelatin) the absorption of the mixture to a measurable level; measuring the absorbance at 595 nm; repeating the above procedure for a number of different dilutions; plotting the results on the x and y axis of a coordinate plane; and, fitting a line within the plotted points. Referring to FIG. 9, the above regressed relationship between concentration and absorbance is drawn to eight data points (one point preferably being of zero concentration) at a R² value of 0.997. Subject thereto, a preferable concentration for the solution is 0.15625 milligrams of gelatin per milliliter of water for most cytological applications yielding an absorbance of 0.91651.

It should be noted that, although gelatin and water have been disclosed in the preferable embodiment, any substances producing a hydrocolloid-type chemical solution when mixed may suitably be used for preparing a cytological specimen without departing from the purposes and concepts of this disclosure.

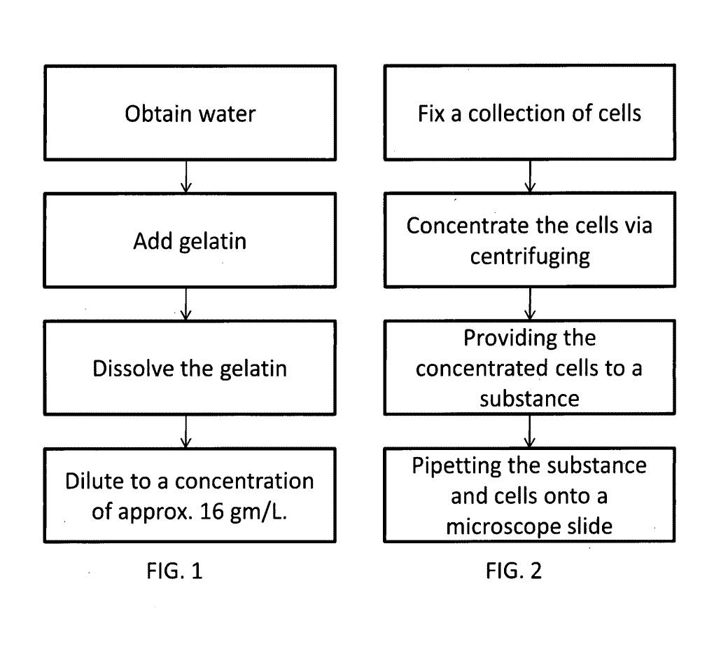

FIG. 1 depicts a flow-diagram of one preferable process for preparing the disclosed substance. The first step is preparing a stock solution via dissolving one-thousand (1000.00000) milligrams of gelatin powerder into one-hundred (100.00000) millileters of distilled water, resulting in a concentration of 10 milligrams per milliletter (“mg/mL”). The second step is diluting the stock solution to a concentration of approximately 0.15625 milligrams of gelatin per millileter of water, using the formula C1V1=C2V2. The result of the disclosed method is preferably the substance disclosed above, which is viscous enough to immobilize a cell after it is pipetted onto a microscope slide. The resulting polymer is preferably colorless, non-hazardous, relatively chemically non-reactive, and/or with a refractive index aproximating that of glass, to give the best possible transparency.

FIG. 2 depicts a flow diagram of the method of preparing a cytological specimen using the disclosed substance. The first step is typically cell fixation. For purposes of the present application, fixation is generally meant to encompass the process of preserving the cells from degradation so they may be observed and/or tested. Fixation may be achieved via chemically modifying liquid or semi-liquid solutions of biomolecules so that a more solidified state results. A suitable cell fixative may be an alcohol or a formaldehyde. The second step may be the step of concentrating the cells via centrifuging. The third step 300 may be the step of suspending the cells in the substance, with compositions that are similar or identical to those identified above. A fourth step may be the step of providing the cells, as suspended in the solution, to a microscope slide.

The disclosed substance has proven effective in the preparation of cytological specimens of: pap smear; Cerebrospinal fluid (CSF); Amniotic fluid; gastric brushings; interstitial fluid; fine needle aspiration (FNA); breast aspirates; pleural fluid; nasal lavage; bucell cell; saliva; urine; and synovial fluid. However, it should be noted that the above list is not all encompassing and other substances may be prepared for microscopic observation with the disclosed substance.

Disclosed now are a series of non-limiting examples concerning the fabrication and typical uses of embodiments of the invention.

### EXAMPLE 1

One application of the disclosed substance may be in preparing cytological specimens for a Pap test. First, cells are collected from the test subject's cervix. Next, the cells are fixed, concentrated, and placed in the above disclosed solution having a concentration of 0.15625 milligrams of gelatin per milliliter of water. Finally, the suspended cells may be provided to a microscope slide via pipetting an amount of the solution onto the slide. Ultimately, the slides will be placed under a microscope whereby the cells are examined for abnormalities that may indicate early stages of cervical cancer.

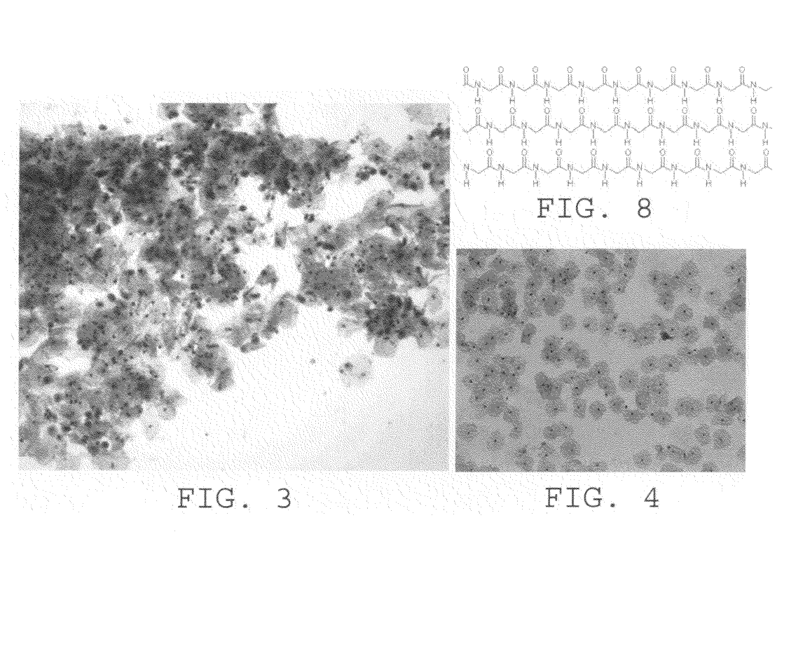

FIGS. 3 and 4 respectively depict photographs of Pap specimens prepared according conventional methods and the presently disclosed methods. As seen in the pictures, the cells suspended in gelatin water solution (FIG. 4) are substantially more observable than the cells placed on the slide by conventional methods (FIG. 5). Accordingly, the above recited method for preparing a Pap specimen represents a significant advancement over the prior art methods.

### EXAMPLE 2

Another application of the disclosed substance may be in preparing cytological specimens for a urine sample. The general procedures for preparing a urine specimen correspond with the procedures set forth above in connection with preparing a Pap specimen. FIGS. 5 and 6 respectively depict photographs of urine specimens prepared according to convention methods and the presently disclosed methods. As seen in the figures, the cells suspending in the above disclosed substance (FIG. 6) are more readily observable than cells placed on a slide by conventional methods.

### EXAMPLE 3

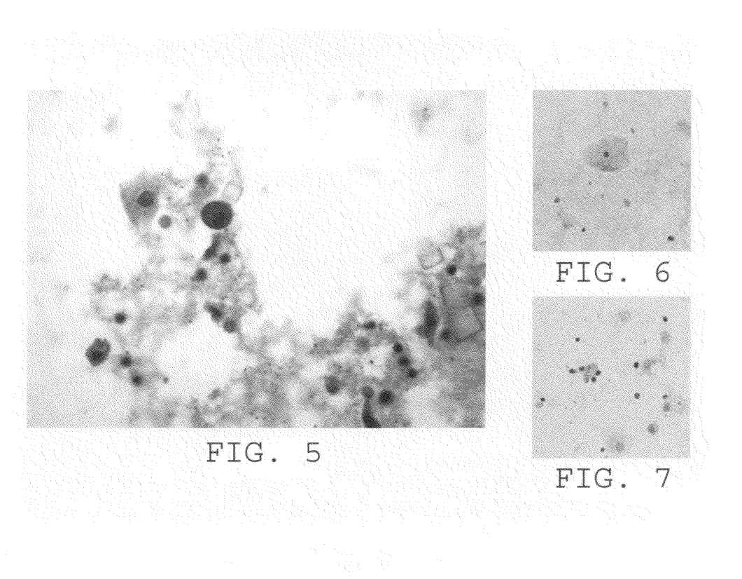

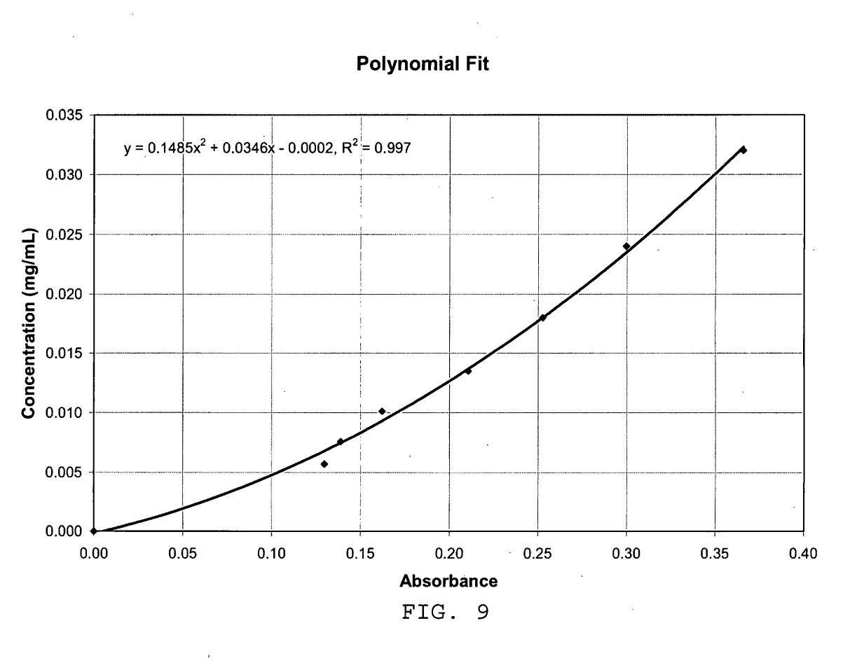

Yet a further example application of the disclosed substance may be in preparing a cytological specimen for a pleural specimen. FIG. 7 is an image of a pleural specimen. As seen in the figure the cells are independently observable.

The above described substance and methods are preferably an advancement over the prior art. Unlike the prior art methods, some of which require a screen or screen-plus-adhesive to create a mono-layer of cells for observation, the presently disclosed substance preferably creates a monolayer of cells when suspended. In addition, using the disclosed substances or methods results in a suitable mono layer of cells without having to: (1) use expensive equipment; (2) replace equipment components for every new specimen; and, (3) provide an independent adhesive to the slide.

It should be noted that the preferable embodiments and the associated description are of illustrative importance only. In other words, the descriptions of the preferred embodiments should not be construed as limiting of the subject matter in this application. The apparatus and methods discussed hereby are susceptible to modification without changing the overall concept of the disclosure. Additional modifications may become apparent to one skilled in the art after reading this disclosure.

In summary, this specification may disclose a substance for preparing cytological specimens comprising a gelatin component, the substance comprising gelatin and water or deionized water in a concentration of approximately a sixteenth of a milligram of gelatin per milliliter (more specifically, 0.15625 mg/mL). Additionally, the specification may disclose a substance for preparing cytological specimens comprising gelatin and water, wherein the substance is a hydrocolloid mixture in which gelatin is dispersed evenly therethrough. Preferably, the substance is transparent and has a refractive index approximating that of clear glass. The specification may further disclose a method of preparing a cytological specimen comprising the steps of obtaining a hydrocolloid mixture comprising gelatin and water, suspending at least one cell in the solution, and providing the cell and solution to a microscope slide, wherein the hydrocolloid mixture features a gelatin concentration of approximately a sixteenth of a milligram per milliliter. The identified method may further comprise the step of fixing a cell. Also disclosed may be a method of preparing a cytological specimen comprising the steps of mixing gelatin and water to produce a substance, suspending at least one cell in the substance, and providing the cell and substance to a microscope slide.

I claim:

1. A method of preparing a cytological specimen:
dissolving gelatin in water to produce a substance;
fixing more than one cell;
concentrating the cells;
suspending the fixed and concentrated cells in the substance; and,
pipetting the suspended cells onto a microscope slide.

2. The method of claim 1 wherein the cytological specimens is for a Pap test.

3. The method of claim 1 wherein the cytological specimens is for a urine sample.

4. The method of claim 1 wherein the cytological specimens is for a pleural specimen.

5. The method of claim 1 wherein the concentration of the substance is:
(a) less than or equal to one gram of gelatin per milliliter of water; and
(b) greater than or equal to one microgram of gelatin per milliliter of water.

6. The method of claim 1 wherein the concentration of the substance is about 0.156 milligrams of gelatin per milliliter of water.

7. The method of claim 1 wherein the step of dissolving gelatin in water to produce the substance comprises the steps of:
dissolving one-thousand milligrams of gelatin into one-hundred millileters of water to produce a stock; and
diluting the stock with water to produce the substance, said substance having a concentration of
(a) less than or equal to one gram of gelatin per milliliter of water, and
(b) greater than or equal to one microgram of gelatin per milliliter of water.

8. The method of claim 1 wherein the step of dissolving gelatin in water to produce the substance comprises the steps of:
dissolving one-thousand milligrams of gelatin into one-hundred millileters of water to produce a stock; and
diluting the stock with water to produce the substance, said substance having a concentration of about 0.156 milligrams of gelatin per milliliter of water.

9. The method of claim 1 wherein the step of dissolving gelatin in water to produce a substance comprises the steps of:
identifying a desirable absorbance for the specimen;
solving the equation, y=0.1485x²+0.346x−0.0002, for y, wherein x is the value of the desirable absorbance;
dissolving one-thousand milligrams of gelatin into one-hundred millileters of water to produce a stock; and,
preparing the substance by diluting the stock solution with water to a gelatin concentration of the solved value for y milligram-per-millileter.

10. A method of immobilizing at least one cell on a microscope slide, the method comprising the steps of:
fixing the cell(s);
concentrating the cell(s);
providing the cell(s) to a substance comprising water and gelatin; and,
providing the cell(s) and substance to the microscope slide.

11. The method of claim 10 wherein the concentration of the substance is 0.156 grams of gelatin per liter of water.

12. The method of claim 10 wherein the value of the concentration of the substance is pre-determined by the steps of:
identifying a desirable absorbance for the specimen; and,
solving the equation, y=0.1485x²+0.346x−0.0002, for y, wherein x is the value of the desirable absorbance and y is the value of the concentration in grams of gelatin per liter of water.

13. The method of claim 10 wherein the concentration of the substance is:
(a) less than or equal to one gram of gelatin per milliliter of water; and
(b) greater than or equal to one microgram of gelatin per milliliter of water.

14. The method of claim 10 wherein the cytological specimens is for a Pap test.

15. The method of claim 10 wherein the cytological specimens is for a urine sample.

16. The method of claim 10 wherein the cytological specimens is for a pleural specimen.

17. A method of using a microscope comprising the steps of:
selecting at least one cell to be observed under at least one lens of the microscope;
fixing the cell(s);
concentrating the cell(s);
providing the cell(s) to a substance comprising water and gelatin;
providing the cells and substance to a microscope slide; and,
observing the cell via the microscope.

18. The method of claim 17 wherein the concentration of the substance is 0.156 milligrams of gelatin per milliliter of water.

19. The method of claim 17 wherein the value of the concentration of the substance is pre-determined by the steps of:
identifying a desirable absorbance for the specimen; and,
solving the equation, y=0.1485x²+0.346x−0.0002, for y, wherein x is the value of the desirable absorbance and y is the value of the concentration , in grams of gelatin per liter of water.

20. The method of claim 17 wherein the concentration of the substance is:
(a) less than or equal to one gram of gelatin per milliliter of water; and
(b) greater than or equal to one microgram of gelatin per milliliter of water.
